(19) United States
(12) Patent Application Publication
(10) Pub. No.: US 2006/0015907 A1
(43) Pub. Date: Jan. 19, 2006

(54) Broadcast program information display apparatus and broadcast program information display method

(75) Inventor: Ryoji Nakata, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/173,165

(22) Filed: Jul. 5, 2005

(30) Foreign Application Priority Data
Jul. 5, 2004 (JP) 2004-198317

(51) Int. Cl. G06F 13/00; G06F 3/00; H04N 5/445

(52) U.S. Cl. 725/59

(57) ABSTRACT

A broadcast program information display apparatus comprises a receiver which receives program information of channels, a display device which displays program information in a certain time zone on one channel, and a selector which switches displayed program information to program information in the same time zone or in a close time zone on another channel.

### CROSS-REFERENCE TO RELATED APPLICATIONS

This application is based upon and claims the benefit of priority from prior Japanese Patent Application No. 2004-198317, filed Jul. 5, 2004, the entire contents of which are incorporated herein by reference.

### BACKGROUND OF THE INVENTION

1. Field of the Invention

The present invention relates to a broadcast program information display apparatus and a broadcast program information display method and, more particularly, to a broadcast program information display apparatus and a broadcast program information display method which displays an electronic program table on the basis of electronic program guide (EPG) data transmitted from a broadcasting station together with a broadcasting wave or additionally supplied through a network such as the Internet.

2. Description of the Related Art

At present, as method for notifying a user of a broadcasting schedule of broadcast programs, various methods which use an EPG in place of paper media such as newspapers or magazines are proposed. As a typical method, a method which transmits television signals such as ordinary video and audio signals and EPG information as data information and demodulate the data information on a reception side to reproduce an EPG screen on the display of a receiver is employed (for example, FIGS. 3 to 6 in Jpn. Pat. Appln. KOKAI Publication No. 2001-186436). Since a general television screen is horizontally long, the EPG screen is displayed such that a time axis is vertically set and a plurality of channels are horizontally arranged. Both the time and the channels can be scrolled.

In recent years, mobile broadcasting which gives a multi-channel broadcasting service to a user who is on the move is going to be in practical use. Since the mobile broadcasting sends a radio wave (using frequency in 2.6-GHz band called an S band) stronger than a wave used in conventional BS broadcasts or CS broadcasts (using frequency in a 12-GHz band), a mobile receiving terminal is designed to be able to receive the broadcast with a small-size antenna on the move. A screen of the mobile receiving terminal for the mobile broadcasting is so small that a conventional EPG screen cannot be displayed. For this reason, a new EPG screen must be designed. In this manner, a conventional broadcast program information display apparatus is disadvantageously unsuitable for a small-size receiving terminal.

### BRIEF SUMMARY OF THE INVENTION

It is an object of the present invention to provide a broadcast program information display apparatus and a broadcast program information display method which can display program information even on a small-size receiving terminal.

According to an embodiment of the present invention, a broadcast program information display apparatus comprises a receiver which receives program information of channels, a display device which displays program information in a certain time zone on one channel, and a selector which switches displayed program information to program information in the same time zone or in a close time zone on another channel.

According to another embodiment of the present invention, a broadcast program information display method comprises a step of receiving program information of channels; a step of displaying program information in a certain time zone on one channel; and a step of switching the displayed program information to program information in the same time zone or in a close time zone on another channel.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a diagram showing an outline of a broadcast receiving terminal which uses a broadcast program information display apparatus according to embodiments of the present invention;

FIG. 2 is a block diagram showing a configuration of a broadcast program information display apparatus according to the first embodiment of the present invention;

FIG. 3 is a diagram showing an example of a broadcast program information display;

FIG. 4 is a diagram showing another example of the broadcast program information display;

FIG. 5 is a diagram showing still another example of the broadcast program information display;

FIG. 6 is a diagram showing still another example of the broadcast program information display;

FIG. 7 is a diagram showing still another example of the broadcast program information display; and

FIG. 8 is a flow chart showing an operation of the broadcast program information display apparatus according to the first embodiment of the present invention.

### DETAILED DESCRIPTION OF THE INVENTION

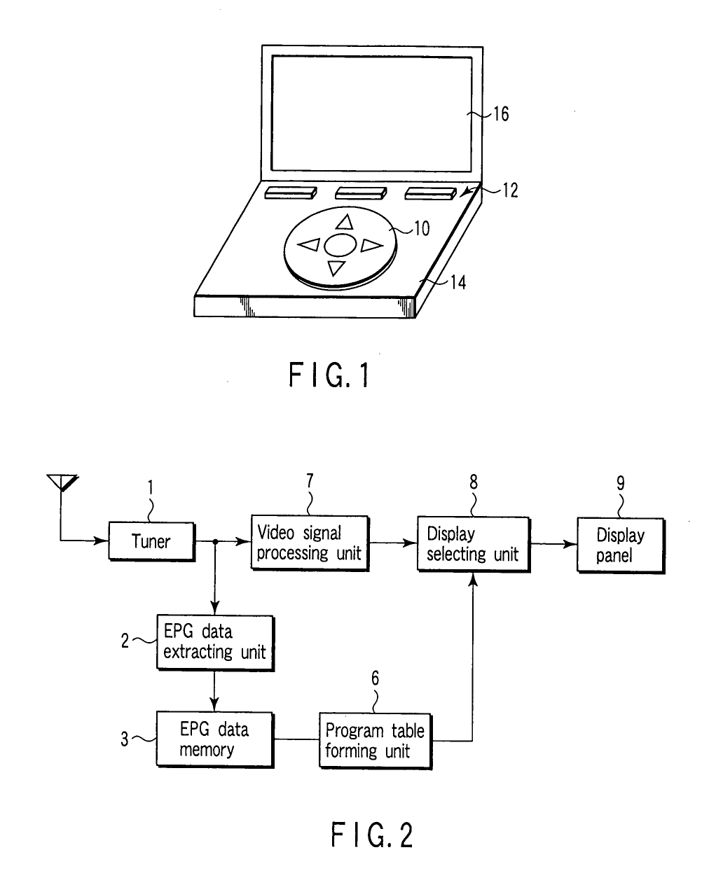

FIG. 1 shows an outline of a receiving terminal device for mobile broadcasting which uses a broadcast program information display apparatus according to embodiments of the present invention. The appearance is similar to the appearance of a compact notebook-type personal computer or a PDA device. A display panel 16 such as a liquid crystal display panel is fixed to a device body 14 to be freely opened and closed. The device body 14 has an arrow key 10, various operation buttons 12 such as an EPG display button, a program button, and an on-air program button. Although not shown, voice is reproduced from a small-size loudspeaker or a headphone.

FIG. 2 is a block diagram showing the configuration of the broadcast program information display apparatus according to the first embodiment of the present invention. The broadcast program information display apparatus is constituted by a tuner 1, an EPG data extracting unit 2, an EPG data memory 3, a program table forming unit 6, a video signal processing unit 7, a display data selecting unit 8, and a display panel 9. Although not shown because it is not directly related to the subject matter of the present invention, an output from the video signal processing unit 7 is stored in a recording medium such as a memory card to record a programmed broadcast program.

The tuner 1 receives a channel of a specific broadcasting station, receives video and audio data, and receives electronic program guide (EPG) data from the broadcasting station. A program also includes a radio program constituted only by audio data. The EPG is data of a broadcast schedule of TV programs transmitted from a television broadcasting station, e.g., every week. Each program is constituted by a program name or title, start time, end time, classification, an explanation of program contents, and the like.

The EPG data extracting unit 2 separates the EPG data from a received signal output from the tuner 1 and stores the EPG data in the EPG data memory 3. In the program table forming unit 6, data processing for EPG display is carried out on the basis of the EPG data stored in the EPG data memory 3 to make it possible to perform program display by the EPG on the display panel 9.

In the video signal processing unit 7, video data is extracted from the received signal output from the tuner 1 to perform video signal processing. In the display data selecting unit 8, depending on a designation from the operation buttons 12 (FIG. 1) for EPG display performed by an audience, display of a video or display of an electronic program table is selected. The display data selecting unit 8 is ordinarily set to select video information from the video signal processing unit 7 and to display the video information on the display panel 9.

In the EPG display according to the embodiment, only information of a predetermined number of programs of one channel is displayed because the screen of the display panel 9 is small. However, the pieces of program information can be scrolled or switched in a direction of time or channel. For this reason, sufficient program information can be displayed even in a small-size mobile broadcast receiver. As programs to be displayed, three programs including, as the head of the list, a program including current time (program which is on air at present) are displayed. When an operation for advancing time is performed, information of the next set of three programs is displayed. When an operation for switching channels is performed, the program information is switched to the program information of the adjacent channel. However, a program in a time zone close to the current time is not displayed, but a program in a time zone close to a time zone of the programs displayed before the channels are switched is displayed. For this reason, programs of different channels in the same time zone can be compared with each other. This is convenient to determine a program which a user wants to see most.

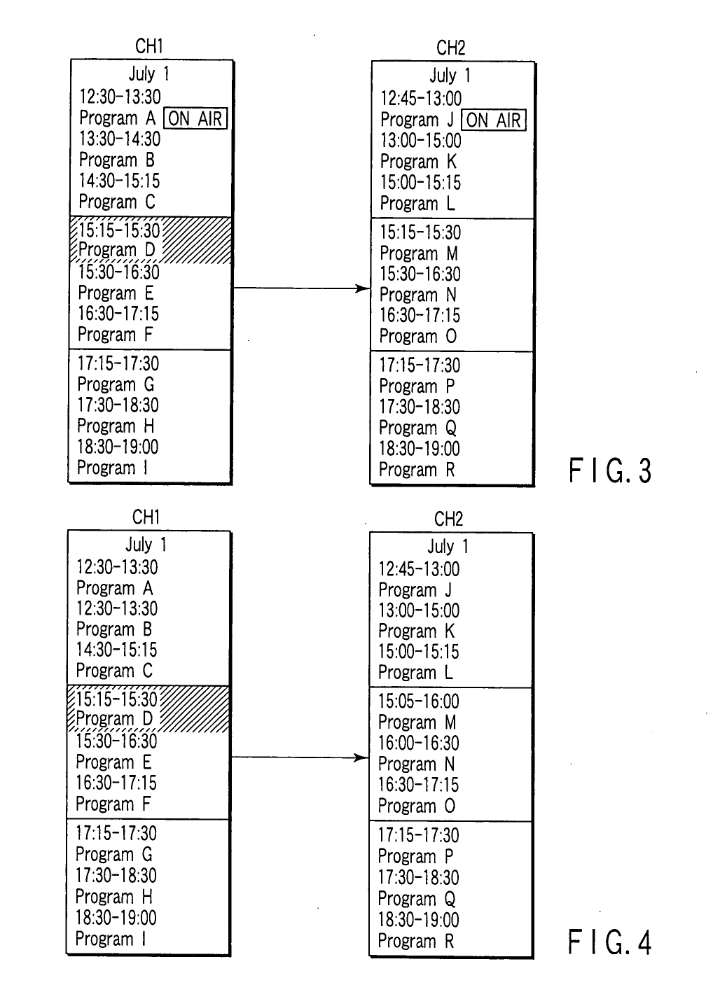

FIGS. 3 to 7 show various display examples obtained when a channel switching operation is performed.

The example in FIG. 3 shows that, when the channels are switched, three programs including, as the head of the list, a program having start time equal to the start time of a program selected from three programs displayed before the channels are switched are displayed.

When the operation button 12 for EPG display is pressed, program information of three programs are displayed in chronological order in the vertical direction of the screen such that a program which is on air at present in a predetermined channel (channel 1 in this case) is first on the list. If no program is on air at present, program information of three programs is displayed such that a program to be started at the closest future time is first on the list. When the current time is 12:45, as shown on the left in FIG. 3, program information of program A scheduled from 12:30 to 13:30, program B scheduled from 13:30 to 14:30, and program C scheduled from 14:30 to 15:15 is displayed on an EPG screen.

The program information generally includes a time zone (from start time to end time) of a program and a program name. However, in addition to a simple program name, a classification of the program, an explanation of program contents, and the like may also be displayed. When the number of characters of text information such as a program name or the like is so large that all the text information cannot be displayed, the text information is displayed in small font.

A program being on air at present is displayed in different format (for example, colors, fonts, flickering, or the like) such that the program can be discriminated from another program. In the illustrated example, an “ON AIR” mark representing “on air” is added.

A date is also displayed at the top of the EPG display screen. However, the date is not the date of today, and is based on start date and time of the top program. For this reason, time when the displayed program is on air can be known.

Although the program information of the three programs is displayed, any one of the programs is being selected. In the initial state, it is assumed that the top program is being selected. Program information which is being selected is different from other program information in display format (for example, colors, fonts, flickering, or the like) and discriminated from the other program information. In this case, the pieces of program information are displayed in different colors.

On the EPG display screen, when an execution key (circle key at the center) of the arrow key 10 or the operation button 12 for EPG display is pressed, the selection is fixed, and the EPG display is switched to a video display of the selected program by the operation of the display data selecting unit 8. Alternatively, on the EPG display screen, when the operation button 12 for programming is pressed, a program which is being selected is programmed. When the program is programmed, when it is programmed time, the tuner 1 automatically receives the program to store broadcast data in a memory card.

On the EPG display screen, when a “time+” key (downward key) or a “time−” key (upward key) of the arrow key 10 is pressed, the selected program vertically moves, a program in a different time zone is selected. While the top or the bottom program of the three programs is being selected, when the upward key or the downward key is pressed, the displayed information is switched to the information of the previous set of three programs or the next set of three programs. Alternatively, when the upward key or the downward key is continuously pressed twice (like a double click of a mouse of a personal computer), the displayed information may be immediately switched to the information of the previous set of three programs or the next set of three programs.

On the EPG display screen, when a “channel+” key (right-pointing key) or a “channel−” key (left-pointing key) of the arrow key is pressed, the display channels of the EPG are switched. However, in this stage, the selected channel of the tuner 1 is not switched, and voice of channel 1 is output. When the display channels are switched, a program displayed in the initial state is a program having start time equal to the start time of the program selected before the channels are switched. For example, when the right-pointing key is pressed while a program D scheduled from 15:15 to 15:30 on channel 1 is being selected, a program scheduled from 15:15 to 15:30 on channel 2 is displayed as the head of the list. Also in this state, when the upward key or the downward key is pressed, a program in another time zone on channel 2 is displayed.

An example in FIG. 4 shows that, when channels are switched, there is no program having start time equal to the start time of a program selected before the channels are switched. In this case, a program (which is started before the start time of the selected program and which is being on air at the start time of the selected program) in a time zone including the start time is displayed first. More specifically, when the right-pointing key is pressed while the program D scheduled from 15:15 to 15:30 on channel 1 is being selected, there is no program which starts at 15:15 on channel 2. Therefore, on channel 2, program M scheduled in a time zone (15:05 to 16:00) including 15:15 is displayed as the head of the list.

An example in FIG. 5 shows that, when there is no program having start time equal to the start time of a program selected before channels are switched, and when there is no program in a time zone including the start time, a program having end time equal to the start time is displayed first. More specifically, when the right-pointing key is pressed while the program D scheduled from 15:15 to 15:30 on channel 1 is being selected, there is no program which starts at 15:15 on channel 2, and there is no program which starts before 15:15 and is being on air at 15:15. Therefore, program M which ends at 15:15 on channel 2 is displayed as the head of the list.

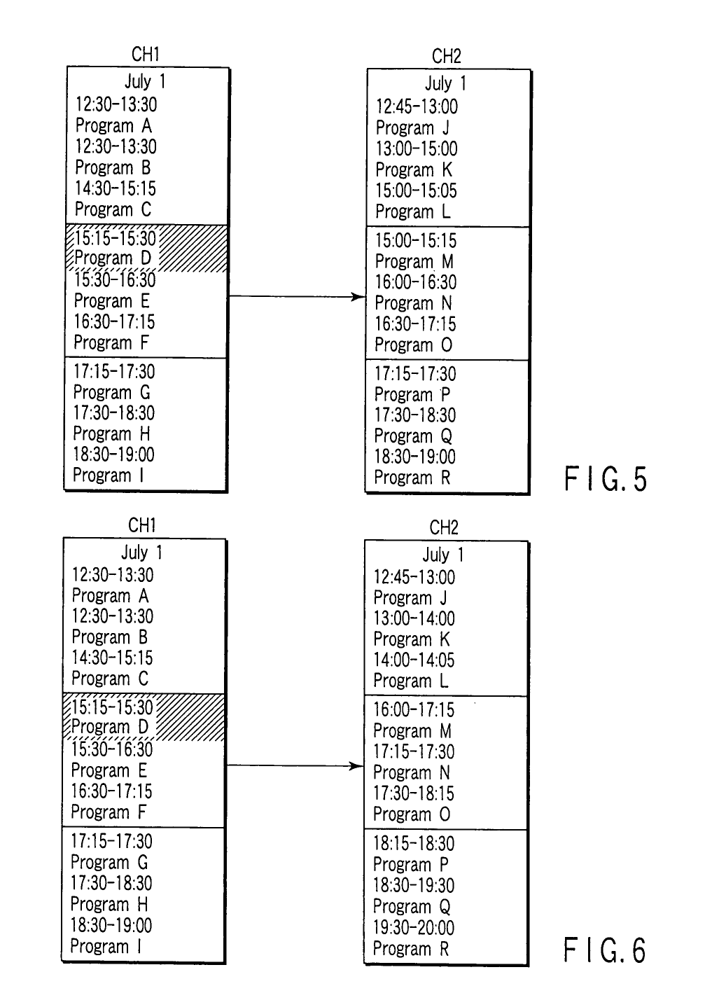

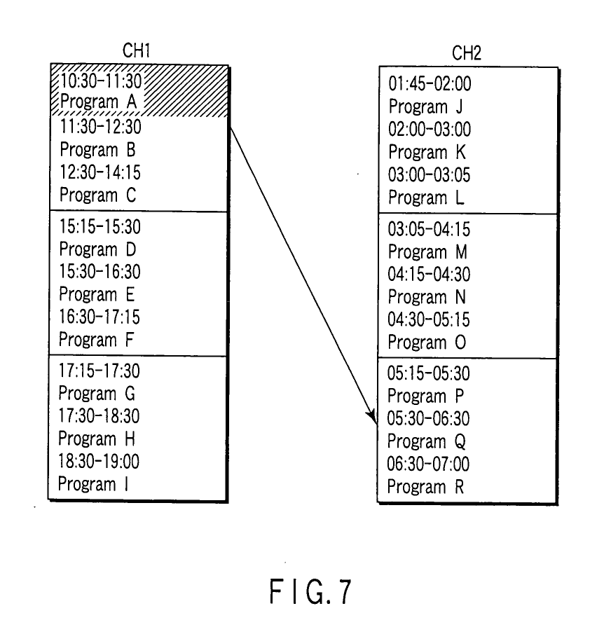

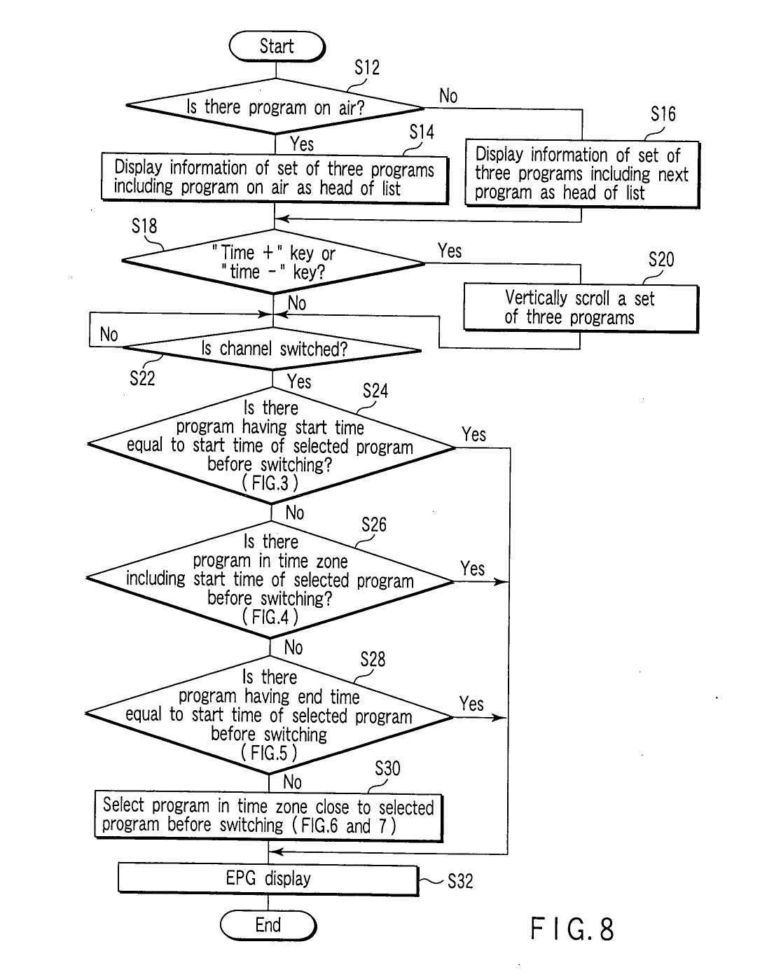

An example in FIG. 6 shows that, when channels are switched, when there is no program having start time equal to the start time of a program selected before the channels are switched, when there is no program in a time zone including the start time, and when there is no program having end time equal to the start time, a program which starts at the closest future time is displayed. More specifically, when the right-pointing key is pressed while the program D scheduled from 15:15 to 15:30 on channel 1 is being selected, there is no program which starts at 15:15 on channel 2, there is no program which starts before 15:15 and is being on air at 15:15, and there is no program which ends at 15:15. Therefore, program M which starts at 16:00 on channel 2 is displayed as the head of the list.

An example in FIG. 7 shows that, when channels are switched, when there is no program having start time equal to the start time of a program selected before the channels are switched, when there is no program in a time zone including the start time, when there is no program having end time equal to the start time, and when there is no program which starts in future time, a set of programs at the closest past time is displayed first. More specifically, when the right-pointing key is pressed while a program A scheduled from 10:30 to 11:30 on channel 1 is being selected, there is no program broadcasted afterward on channel 2. For this reason, a program P scheduled from 5:15 to 5:30 is displayed as the head of the list.

In any case in FIGS. 3 to 7, when the channels are switched while a certain program is being selected on a certain channel, a program in a time zone close to the time zone of the selected program is displayed. In this manner, program information of all channels can be displayed even on a small-size display screen, and programs on another channel can be searched in the same time zone. This is convenient to find a program an audience wants to watch.

In the embodiment, when the operation button 12 for EPG display is pressed, the current time is set as reference time. Program information of three programs in a time zone including the reference time is displayed. When channels are switched, program information of three programs in a time zone including the reference time or a time zone close to the reference time is displayed. The reference time does not change unless the time+ key or time− key (upward key or downward key) is pressed. When the time+ key or time− key is pressed to shift the three programs to be displayed, the start time of the uppermost program of the three displayed programs is set as the reference time. For this reason, even if the time zone of a program to be displayed considerably shifts as shown in FIG. 7 because no program is on air in a close time zone on the switched channel, the display screen returns to a display screen on the left in FIG. 3 in which a program on air at present or a program to be started at the closest future time is first on the list unless the time+ or time− key is pressed once when the display returns to the display of channel 1 again.

When a current broadcasting button (included in the operation buttons 12) is pressed while an arbitrary program is being selected, information of three programs including, as the head of the list, a program on air at present on the corresponding channel is displayed.

FIG. 8 is a flow chart showing an operation of the embodiment. When the power supply of the apparatus body is turned on, or when the operation button 12 for EPG display is pressed in display of video, it is determined in step S12 whether there is a program being on air at present on a predetermined channel (e.g., channel 1). When there is a program being on air, information of three programs including the program on air as the head of the list is displayed in step S14. When there is no program on air, information of three programs including, as the head of the list, a program to be started in the closest future time is displayed in step S16.

It is determined in step S18 whether the upward key or the downward key is operated. Depending on the operated key or the operation, a selected program vertically moves or the set of three programs vertically moves in step S20.

It is determined in step S22 whether the right-pointing key or the left-pointing key is operated. Depending on the operated key, channels are switched, and it is determined in steps S24, S26, S28, or S30 whether the condition in FIGS. 3, 4, 5, or 6 (or 7) is satisfied.

An EPG screen constituted by information of three programs including, as the head of the list, the program selected is displayed in step S32.

As described above, according to the first embodiment, the display panel 9 displays only information of only three programs on one channel. However, since program information can be scrolled or switched in a direction of time or channel, sufficient program information can be obtained even in a small-size mobile broadcast receiver.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein. For example, a broadcasting wave need not be input to a tuner through an antenna, and broadcasting data may be input to a personal computer, a set-top box, or the like through the Internet. As media to be applied, not only a TV program but also a radio program can be applied. On an EPG display screen, although the direction of time is vertically set, three pieces of program information may be displayed in the horizontal direction of the screen. In the initial state of the EPG display, a predetermined channel (channel 1 in this case) is displayed. However, a program on a channel received at the last may be displayed. As a video terminal, not only a mobile broadcasting terminal but also another mobile small-size broadcast program receiving terminal may be applied.

What is claimed is:

1. A broadcast program information display apparatus comprising:
a receiver which receives program information of channels;
a display device which displays program information in a certain time zone on one channel; and
a selector which switches displayed program information to program information in the same time zone or in a close time zone on another channel.

2. The broadcast program information display apparatus according to claim 1, wherein
the selector switches program information displayed at present to program information on another channel having start time equal to start time of the program information displayed at present.

3. The broadcast program information display apparatus according to claim 1, wherein
the selector switches program information displayed at present to program information on another channel in a time zone including start time of the program information displayed at present.

4. The broadcast program information display apparatus according to claim 1, wherein
the selector switches program information displayed at present to program information on another channel having end time equal to start time of the program information displayed at present.

5. The broadcast program information display apparatus according to claim 1, wherein
the selector switches program information displayed at present to program information on another channel having future start time closest to start time of the program information displayed at present.

6. The broadcast program information display apparatus according to claim 1, wherein
the display device displays broadcast times and program names of a plurality of programs in chronological order in a vertical direction.

7. The broadcast program information display apparatus according to claim 6, wherein
the display device displays program information being on air at present to make it possible to identify the program information.

8. The broadcast program information display apparatus according to claim 6, wherein
the display device displays program information such that fonts of characters are changed depending on the number of characters of a program name.

9. The broadcast program information display apparatus according to claim 6, wherein
the selector switches program information displayed at present to program information on another channel of a predetermined number of programs earlier than a program having start time of past time closest to start time of the program information displayed at present.

10. The broadcast program information display apparatus according to claim 6, further comprising:
means for switching time zones of program information to be displayed; and
means for, when a program other than a program being on air at present is displayed, causing an operation of a user to switch the program to a display of program information of the program being on air at present.

11. The broadcast program information display apparatus according to claim 1, wherein
the display device displays broadcasting date and time of a program.

12. A broadcast program information display method comprising:
a step of receiving program information of channels;
a step of displaying program information in a certain time zone on one channel; and
a step of switching the displayed program information to program information in the same time zone or in a close time zone on another channel.

13. The broadcast program information display method according to claim 12, wherein
the switching step comprises a step of switching program information displayed at present to program information on another channel having start time equal to start time of the program information displayed at present.

14. The broadcast program information display method according to claim 12, wherein
the switching step comprises a step of switching program information displayed at present to program information on another channel in a time zone including start time of the program information displayed at present.

15. The broadcast program information display method according to claim 12, wherein
the switching step comprises a step of switching program information displayed at present to program information on another channel having end time equal to start time of the program information displayed at present.

16. The broadcast program information display method according to claim 12, wherein
the switching step comprises a step of switching program information displayed at present to program information on another channel having future start time closest to start time of the program information displayed at present.

17. The broadcast program information display method according to claim 12, wherein
the display step comprises a step of displaying broadcast times and program names of a plurality of programs in chronological order in a vertical direction.

18. The broadcast program information display method according to claim 17, wherein
the display step comprises a step of displaying program information being on air at present to make it possible to identify the program information.

19. The broadcast program information display method according to claim 17, wherein
the display step comprises a step of displaying program information such that fonts of characters are changed depending on the number of characters of a program name.

20. The broadcast program information display method according to claim 17, wherein
the switching step comprises a step of switching program information displayed at present to program information on another channel of a predetermined number of programs earlier than a program having start time of past time closest to start time of the program information displayed at present.

21. The broadcast program information display method according to claim 17, further comprising:
a step of switching time zones of program information to be displayed; and
a step of, when a program other than a program being on air at present is displayed, causing an operation of a user to switch the program to a display of program information of the program being on air at present.

22. The broadcast program information display method according to claim 12, wherein
the display step comprises a step of displaying broadcasting date and time of a program.
